(19) United States
(12) Patent Application Publication
(10) Pub. No.: US 2006/0267372 A1
(43) Pub. Date: Nov. 30, 2006

(54) Vehicle Sun Umbrella

(76) Inventor: George P. Funk, Mesa, AZ (US)

Correspondence Address: MARK V. LOEN, 43649 W BAILEY DR., MARICOPA, AZ, 85239, US

(21) Appl. No.: 11/419,960

(22) Filed: May 23, 2006

Related U.S. Application Data
(60) Provisional application No. 60/685,214, filed on May 27, 2005.

(51) Int. Cl. B60J 11/00

(52) U.S. Cl. 296/136.12

(57) ABSTRACT

A portable sunlight shelter for protecting a motorized vehicle from direct sunlight is disclosed. The sunlight shelter consists of lightweight, elongated structural supports which are attached to the front and rear of a motorized vehicle. Ropes are threaded through the structural support ends above the vehicle to support a flexible material which provides shade. The structural supports, attaching means, and flexible material are easy to put into place and remove. The removable part of the apparatus is easily compacted and stored in the motorized vehicle.

### CROSS-REFERENCE TO RELATED APPLICATIONS

This application claims the benefit of U.S. Provisional Patent Application Ser. No. 60/685,214 filed on May 27, 2005.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM LISTING

Not applicable.

### COMPACT DISC APPENDIX

Not applicable

### BACKGROUND OF THE INVENTION

1. Field of the Invention

This invention is directed to providing a portable and temporary sun shelter for a motorized vehicle.

2. Discussion of Related Art

Others have worked on providing shade for the interior of the vehicle. US patents have been granted that provide sunshade for a vehicle's interior by placing various apparatus inside and outside of the vehicle to block out or reflect sunlight away from the vehicle's interior. Different types of materials have been disclosed as well as various fixtures to adapt the sunscreens to attach to, or be supported by, various internal features of the vehicle. For example, Chai et. al (U.S. Pat. No. 6,357,461) describes an internal sunscreen with an adjustable stiffening frame to fit inside a windshield. Conforti (U.S. Pat. No. 6,682,121) describes a sun shade that partially inhibits sunlight from passing through.

There have also been external methods of providing sunshade for vehicles, but many of these methods have important convenience limitations and are likely to damage the vehicle or vehicle paint. For example, Wang (U.S. Pat. No. 4,805,654) provides for an external shade which is attached to the roof of the vehicle. The placement of the shade is very awkward without a step ladder, and the attaching point on the vehicle roof is likely to damage the vehicle or vehicle paint. The large shade is not conveniently removed from the roof and collapsed into a small compact volume which makes portability unappealing. Rabbit (U.S. Pat. No. 4,718,711) describes a rolled up material that is stretched from the front of the vehicle to the rear of the vehicle to provide shade. This also has important limitations. The flexible shading material is not stiffened by any means to prevent it from flapping in a strong wind. The abrasion of the material against the vehicle when it is put into place is likely, over time, to damage, scuff, or scratch the paint surface.

Gillem (U.S. Pat. No. 5,029,933) provides for an external flexible sunscreen to be attached to the vehicles exterior by straps. However, in addition to the limitations of Rabbit, this does not completely shield the vehicle from the sun which allows UV damage to the vehicle's exterior.

### OBJECTS AND ADVANTAGES

One main goal of this invention is to provide a portable and temporary sunlight shelter for a motorized vehicle that avoids the limitations of vehicle damage and provides for enhanced convenience. It is highly desirable to design the shelter and structural supports so that they can be removed from the vehicle, reduced to a very compact size, and stored inside the vehicle. Alternately, the shelter and structural supports can be stored externally. The apparatus must be adaptable to provide shade for a wide variety of vehicles, including, but not limited to, sedans, station wagons, trucks, jeeps, sport utility vehicles, vans, buses, and many customized vehicles.

This invention provides shade for a motorized vehicle which is an important convenience issue in the southern portion of the United States. It is well known that sunlight can raise the internal temperature of a vehicle to levels that are dangerous. Further, the interior of a vehicle can become so hot that the operator must wait for the vehicle interior to cool down enough to be drivable. In addition, by proper selection of shading material, the shelter can provide important UV protection for the vehicle's interior and exterior. This can improve the value of the vehicle and maintain its physical appearance.

It is also known that a wind will provide difficulties with flexible materials causing a flapping or chafing motion that is likely to damage the vehicle. The design of this invention provides for sturdy support on the front and rear of the vehicle to maintain a sun shelter that will not chafe or damage the vehicle even under windy conditions.

### BRIEF SUMMARY OF THE INVENTION

Accordingly, it is the object of this invention to provide a sun shelter for a vehicle free of any vehicle damage and providing convenience features for the installation, removal, and storage of the shelter components.

### BRIEF DESCRIPTION OF THE SEVERAL VIEWS OF THE DRAWING

FIG. 1 shows an embodiment of the invention where a sedan is protected by a flexible shading material with two pivoting supporting structural members attached to the front and rear of the vehicle.

FIG. 2 shows an embodiment of the invention where a truck is protected by a flexible shading material with three supporting structural members attached to the front and rear of the vehicle.

FIG. 3 shows a detail of how structural support members may be attached to the mounting plate at either end of the vehicle.

FIG. 4 shows a method of locking the elongated structural supports so they will not rotate at their pivot point.

### DETAILED DESCRIPTION OF THE INVENTION

An important embodiment of the invention is where shading is provided by a flexible material that has good longevity and flexibility even when exposed to the sun for extended periods. Materials such as nylon, polypropylene, polyethylene, PET, and various woven materials provide flexibility and weatherability, when proper precautions are taken to ensure that prolonged exposure to sunlight will not degrade or decompose the material. Suitable materials will also be water and mold resistant, and will not tear easily in a wind. Materials commonly used in tents and outdoor dining shelters provide adequate protection and longevity. Various strengthening features, such as fiberglass filaments, may be employed to improve the tear resistance of the material.

The material used in this invention does not have to be rain proof in the sense that the shelter material will not leak when raining. The purpose of the shelter is to keep sunlight off of the car. For example, the ropes that span the structural supports can be stitched to the sheltering material through a long sleeve. The stitching area at the edges of the sleeve does not have to be completely water tight.

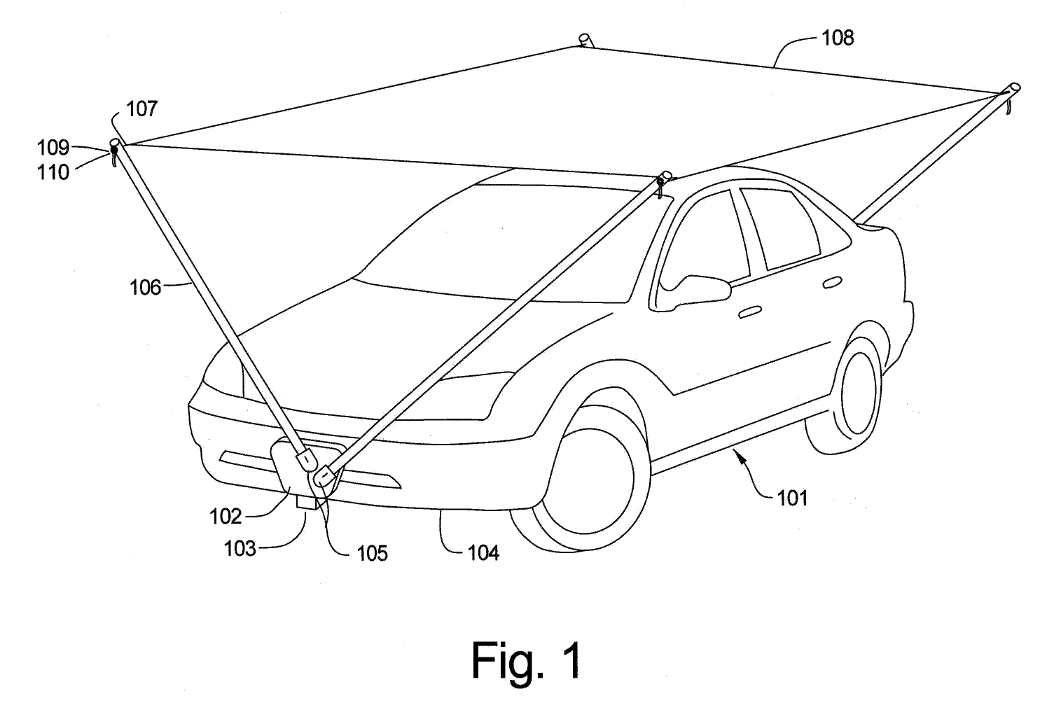

FIG. 1 shows an embodiment of the invention where a sedan is protected by a flexible shading material with two supporting structural members attached to the front and rear of the vehicle. The sedan 101, has a front mounting plate 102, attached to a bracket 103 which is attached underneath the front bumper 104. The front mounting plate 102, has two pivot points 105 where the structural supports 106 are attached. The pivot points 105 are at an angle with respect to ground to allow the structural supports 106 to pivot simultaneously and conveniently toward the driver's side of the vehicle. This allows ready access to the free ends of the structural supports 106 where the ropes 107 inside the shading material 108 may be attached by a person. The ropes 107 are threaded through a hole 109 in the end of the structural support 106. Alternately, a slot could be used instead of the hole 109. The ropes 107 are tied off with knot 110 in a manner that stretches the shading material 108 moderately tight, but not so tight as to bend the structural supports 106 against the vehicle 101. The bracket 103 is attached to the bottom of the bumper 104 by bolts, a clamp, or by welding. Alternately, the bracket 103 can be attached to the structural frame of the vehicle by bolts, a clamp, or by welding. The front mounting plate 102 is attached to the bracket 103 by bolts or welding. Similarly, the back of the sedan 101 has a second duplicate bracket and duplicate mounting plate (not shown).

FIG. 1 shows ropes 107 that are used to secure the flexible shading material 108 to the structural supports 106. Alternately, other flexible members can be used such as strings, chains, wires, or straps. For the purposes of this patent, the term flexible member refers to a flexible member which is stiff under tension and can be coiled up for storage.

The rear of the vehicle will often have a trailer hitch which can be adapted to hold the rear mounting plate securely. The trailer hitch may be used as the rear mounting bracket or an additional member can be adapted to mount on the trailer hitch and securely hold the rear mounting plate.

The structural supports 106 do not have to be made from a single solid piece of material. Telescoping tubing, for example, may be employed to provide sufficient structural strength, and provide for minimal storage space requirements. A number of materials may be employed that include various plastics and metal tubing. It is a distinct advantage to use strong and lightweight materials such as aluminum, titanium or fiberglass. Various commercially common plastic materials also provide suitable strength with a light weight. Such materials include, but are not limited to, polypropylene, polyethylene, PVC, PET, polystyrene, nylon, and various combinations of commercially available plastics. It is desirable to incorporate UV protection in the material.

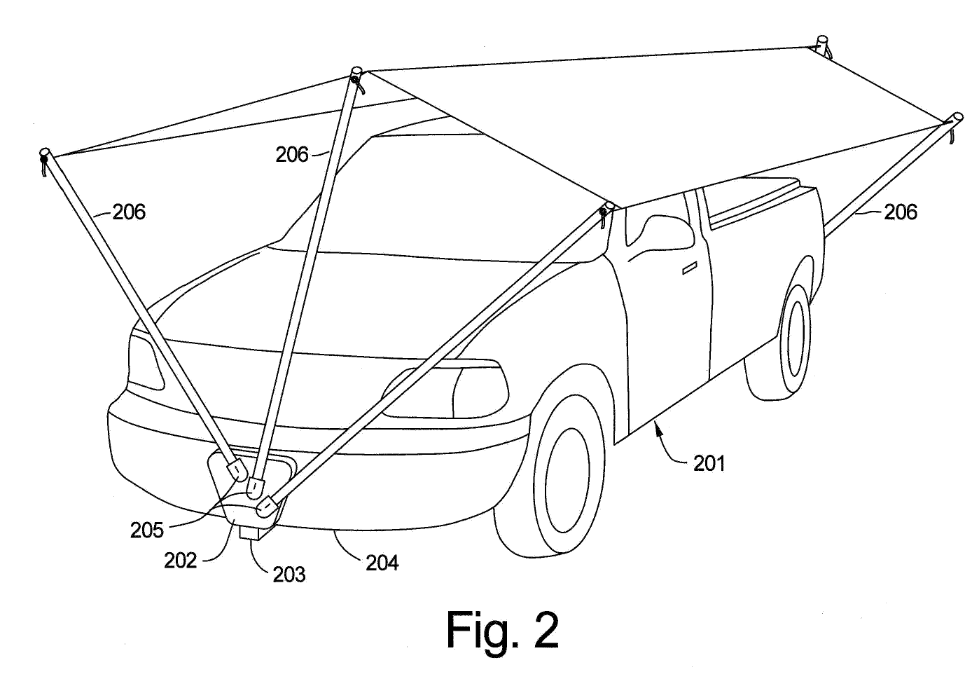

Similarly, FIG. 2 shows an embodiment of the invention where a truck is protected by a flexible shading material with three supporting structural members attached to the front and rear of the vehicle. Similar to FIG. 1, the truck 201 has a front mounting plate 202, attached to a bracket 203 underneath the front bumper 204. The front mounting plate 202, has three pivot points 205 where the structural supports 206 are attached.

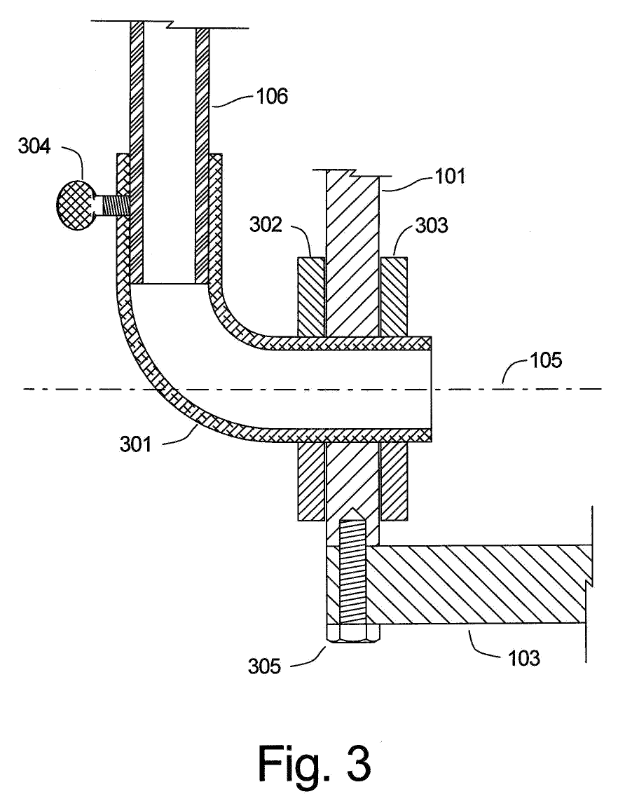

FIG. 3 shows a cross sectional detail of the pivoting feature of the front mounting plate 101. A 90 degree bent tube 301 penetrates the front mounting plate 101 and is free to rotate about axis 105. To allow the bent tube 301 to only rotate, and not slide out of the front mounting plate 101, a front restraining flange 302, and a rear restraining flange 303 are securely attached to the bent tube 301 but not to the front mounting plate 101. The restraining flanges 302 and 303 may be attached by glue, by welding, by bolting, by use of a snap ring, by a press fit, or similar methods that are well known in the art. The end of structural support 106 is temporarily fixed to the bent tube 301 by sliding the end of structural support 106 into the bent tube 301 and clamping with the thumbscrew 304. A matching hole or groove may be created in to the end of structural support 106 to ensure the thumbscrew 304 provides a more secure attachment. A bolt 305 is used to attach the front mounting plate 101 to the mounting bracket 103. As an alternate, the front mounting plate 101 may be welded to the mounting bracket 103.

There are other ways to attach the end of the structural support 106 to the bent tube 301. Use of snap fittings, spring loaded detent balls, threading of the ends, various clamps, tolerance fits, and mechanical locks may also be employed. FIG. 3 illustrates only one possible method.

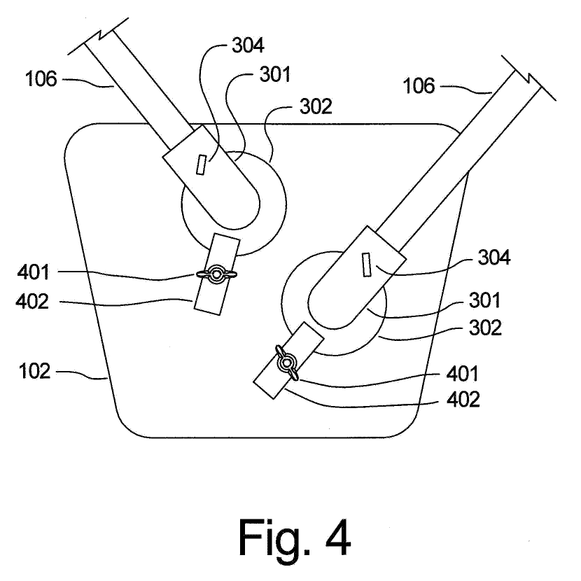

FIG. 4 shows a method of preventing the structural support 106 from rotating. The front support flange 302, which is attached to the bent tube 301, is restrained from moving by a small locking bar 402 which is tightened against the support flange 302 by wing nut 401. A stud bolt (not shown) is fixed to the front mounting plate 102 that is used by wing nut 401. The end of the thumbscrew 304 illustrated in FIG. 3 is also shown.

While various embodiments of the present invention have been described, the invention may be modified and adapted to various similar shading arrangements to those skilled in the art. Therefore, this invention is not limited to the description and figure shown herein, and includes all such embodiments, changes, and modifications that are encompassed by the scope of the claims.

I claim:

1. A sunlight shelter for a vehicle comprising:
a. a first attaching means which is fixed to the front of said vehicle,
b. a second attaching means which is fixed to the rear of said vehicle,
c. a plurality of first removable elongated supports with lower ends that are attached to said first attaching means in a manner to only allow rotation about an axis substantially parallel to a centerline from front to back of said vehicle,
d. wherein said plurality of first removable elongated supports are substantially perpendicular to said axis,
e. a plurality of second removable elongated supports with lower ends that are attached to said second attaching means in a manner to only allow rotation about said axis,
f. wherein said plurality of second removable elongated supports are substantially perpendicular to said axis,
g. wherein an equal number of said first removable elongated supports and said second removable elongated supports are used,
h. wherein said first removable elongated supports and said second removable elongated supports have upper ends that are higher than the lowest of any door handle on said vehicle,
i. a plurality of flexible members which are attached between said upper ends of said first removable elongated supports and said upper ends of said second removable elongated supports,
j. wherein said plurality of flexible members are substantially parallel to each other and placed under sufficient tension so as to approximate a straight line,
k. a first restraining means that is adapted to temporarily prevent said first removable elongated supports from rotating about said axis,
l. a second restraining means that is adapted to temporarily prevent said second removable elongated supports from rotating about said axis,
m. a flexible shading material that is attached to said flexible members, and
n. wherein said flexible shading material has a size at least large enough to provide shade for said vehicle's interior when the sun is directly overhead.

2. The apparatus according to claim 1 wherein all of said removable elongated supports are capable of being rotated about said axis so that all upper ends of said removable elongated supports are on the same side of said vehicle for the purpose of allowing an operator to install said plurality of flexible members and said flexible shading material.

3. The apparatus according to claim 1 wherein all of said removable elongated supports have adjustable lengths.

4. The apparatus according to claim 3 wherein any of said removable elongated supports are made from telescoping tubing.

5. The apparatus according to claim 1 wherein any of said flexible members are made from rope, string, chord, or a narrow band.

6. The apparatus according to claim 1 wherein said flexible shading material is primarily made from polypropylene, polyethylene, polyvinylchloride, polyethylene terephthalate, polystyrene, or nylon by weight.

7. The apparatus according to claim 6 wherein said flexible shading material incorporates UV protection.
